(19) United States
(12) Patent Application Publication
(10) Pub. No.: US 2006/0251481 A1
(43) Pub. Date: Nov. 9, 2006

(54) Drill jig for locating holes to be drilled in a workpiece

(76) Inventor: Gamil Roushdy Nashed Behman, Alxandria (EG)

Correspondence Address: Gamil Roushdy Nashed Behman, 601 Kennedy Blvd., Apt. #1, Bayonne, NJ, 07002, US

(21) Appl. No.: 10/532,941

(22) PCT Filed: Nov. 22, 2003
(86) PCT No.: PCT/EG03/00008

§ 371 Date: Apr. 5, 2006

(30) Foreign Application Priority Data
Dec. 1, 2002 (EG) 2002121294

(51) Int. Cl. B23B 47/28

(52) U.S. Cl. 408/115 R

(57) ABSTRACT

The invention is a guide arm for the use of electric drill. It is very precise, easily operated and has much potential. Sheet no. 1 is a drawing of the invention. Sheet no. 2 is a drawing that represents the components disassembled. The invention is used for carpentry business (mobile furniture) to locate the position of the required holes. Sheet no. 9 illustrates the use of the arm in making a hole in a base or in a ceiling of a wardrobe. Sheet no. 10 illustrates its use in making a hole in a side which is to be placed on a base. Sheet no. 11 illustrates its use in placing wooden cylinders on the sides. Sheet no. 12 illustrates its use in placing a side on a base.

### TECHNICAL FIELD

The invention is used for making carpentry, through the use of that arm as a guide for the electric drill, instead of using the electric drill without a guide. it is used for making the hole required in the base and the ceiling of a wardrobe, and for making holes in the sides, and placing wooden cylinders in the sides, and placing the side on the base, properly. see sheets no. 1,2,6,7,8 and 9

### BACKGROUND ART

it is an arm, which is easily operated, very precise and it has much potential it saves time and can achieve guaranteed results.

### DISCLOSURE OF INVENTION

It is composed of an arm which is used as a guide for the electric drill. It is very precise, easily operated of two arms. 11 and 11. See sheets no 1,2 &3 (illustration of projections) sheet no. 1 and 2 and sheet no. 4 illustrate their projections 21 and 21 move to enter 11 and 11, and joined by the tack 67 which enters the nut's hole in the arm, 21 enters to the right and 21 enters to the left. And 75 and 75 enter 65 and 65 and locate the angles required along the axis of the two arm 11 and 11 we determine the distance between 11 and 11 then we fasten by the two tacks 66 and 66 see sheets no. 1 and 2. we insert 85 into 76 following determining the angle required, in a direction-which is perpendicular to the two arms 11 and 11. then we fasten the tack 86 by the nut 61 to stabilize the position.

The unit is fixed on a wooden base, or on the required side's thickness through the use of 71, and then we insert the electric drill's bite into 87

Thus we can use the electric drill with this guide to obtain very precise accurate results see sheets no. 9,10,11 and 12.

### DESCRIPTION OF DRAWINGS

11 and 11 they are two arms taking the shapes in sheet no. 1 and 2. sheet no. 3 illustrates the projections the arms 11 and 11 have graduated holes 55 (the holes are designed for the tack 67 is entered . . . nuts), at different distances: 1,2 into the holes according to the required distance from the start point 56. also they have lower holes 57 which theunit 71 is fixed, to fix a clamp upon use, to clamp the instrument (arm) to the woods to be perforated.

2. 21 and 21: they have the shape illustrated in sheet no. 1 and sheet no. 2 whereas shet no. 5 illustrates the projections 65 and 65 are two hollow cylinders, and are gear like, to allow 75 and 75 to make engles along the axis of the two arms 11 and 11 the tacks 66 and 66 are for fastening, after adjusting, the dimensions of 76 and 65 and 65 and adjusting the angle in the direction of the axis of the two arms 11 and 41.

21 and 21 enter 11 and 11 and are moved according to the required distance from 56 (starting guide) then 21 and 21 are fastened by two tacks 67 and 67

3. 76, 75 & 75 see sheets no. 1 and 2. see sheet no. 6 to find the projections.

76 is a hollow cylinder it is gear like to allow 85 to enter and to make angles in the direction vertical to the arms 11 and 11 75 and 75 are vertical to the axis of the cylinder 76. 75 and 75 are two solid cylinders, and they are gear like, externally. They enter 65 and 65 to give angles in the direction of the axis 11 and 11

61 is the nut which joins 85 after entering 76 after determining the angle required, in a direction vertical to the rms 11 and 11. (Thy internal diameter of 76=external diameter of 85)

The internal diameter of 65=external diameter of 75) 4. 87 and 85: see sheets no. 1,2 and see sheet no. 7,8 for the projections. 87 is a hollow cylinder which receives the electric drill's bite to make holes as required and has part 51, see sheet no. 8. it has external diameters which are equal to the inner diameter of cylinder 87. it has different inner radii so we use a large number of electric drill's bites according to our needs 51 enters 87, see sheet no. 2 and sheet no. 8.

There are a large number of 51 with different inner diameters and the external diameter remains the same 85 is a solid cylinder, and it is gear like externally, to allow making angles perpendicular to the axis of the two arms 11 and 11, when 85 enters 76.

85 is a cylinder which is perpendicular to cylinder 87. 85 ends with a thinner cylinder 86 which acts as tack to be dastened to nut 61 after determining the required, angle That is to mean, 85 enters 76 and then, it is fastended by nut 61

5—fig (21), fig (31), fig (41), fig (51), fig (61) can be more than twice can be reperated

### BEST MODE FOR CARRYING OUT THE INVENTION

This nvention can be carried out by using the suitable materials, which are up to the factory.

### INDUSTRIAL APPLICABILITY

This invention can be used in any manufacturing tasks which require making holes precisely

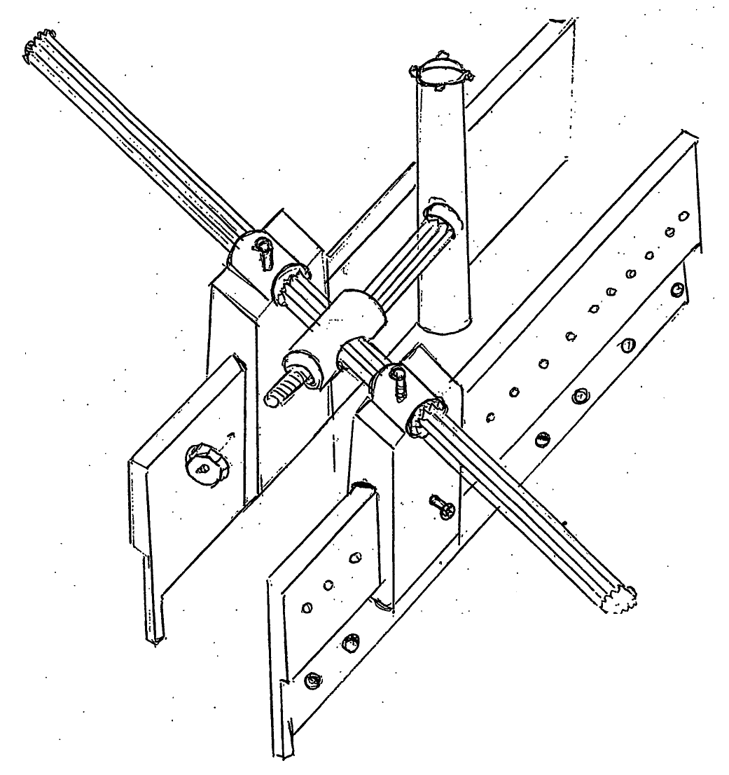

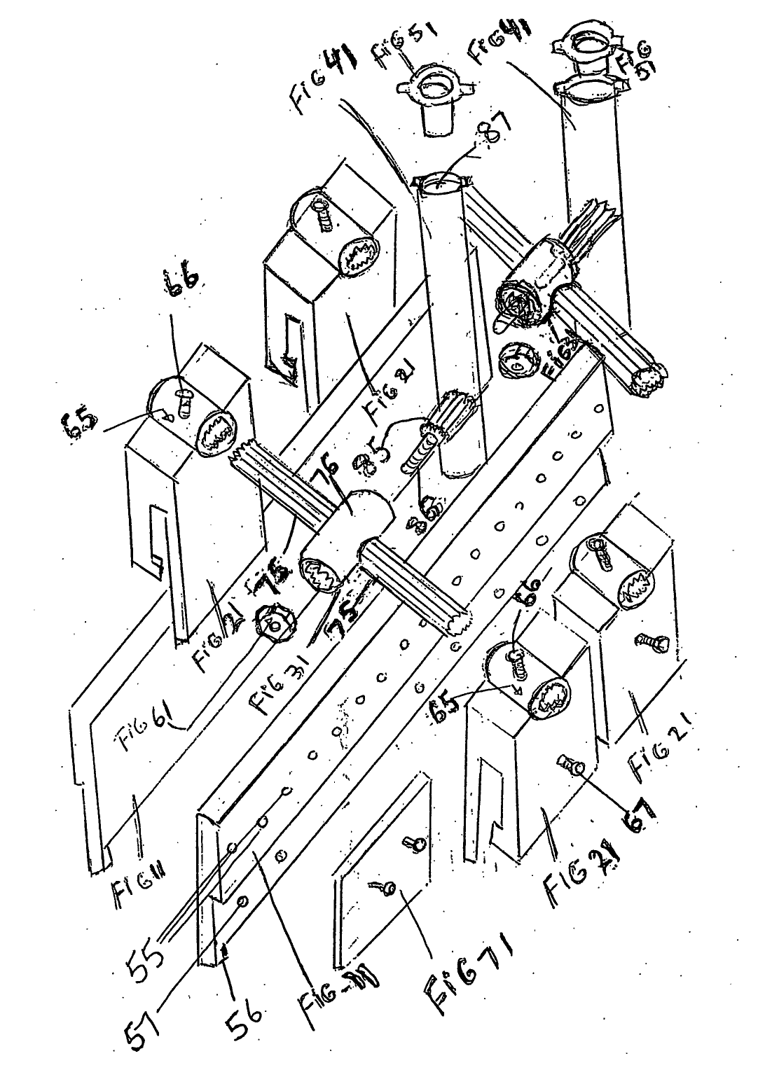

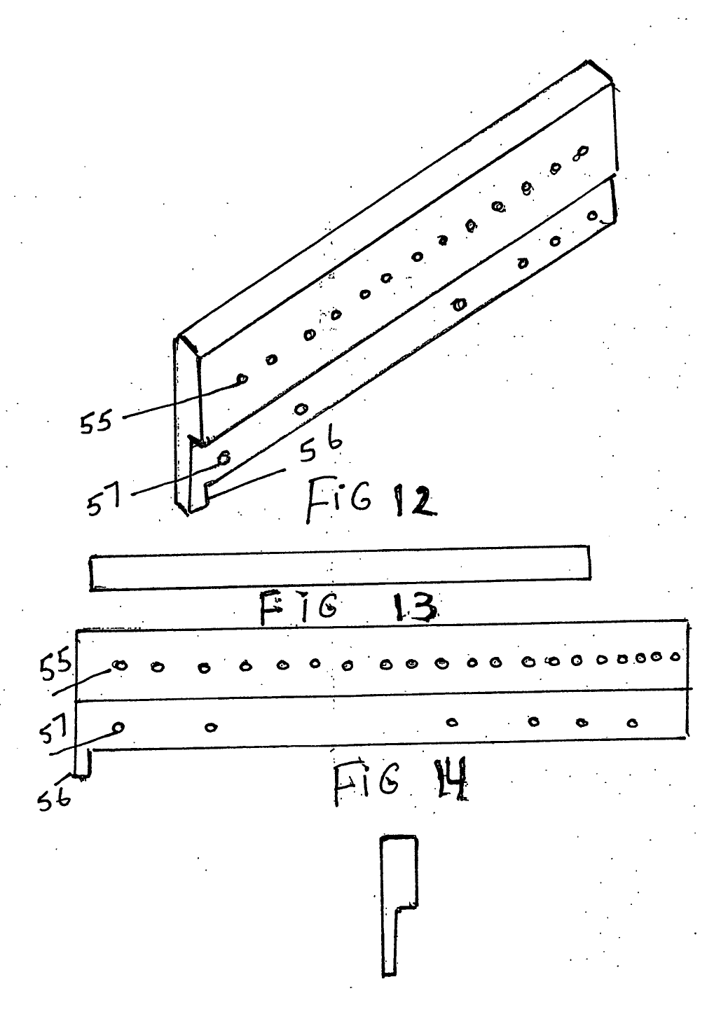

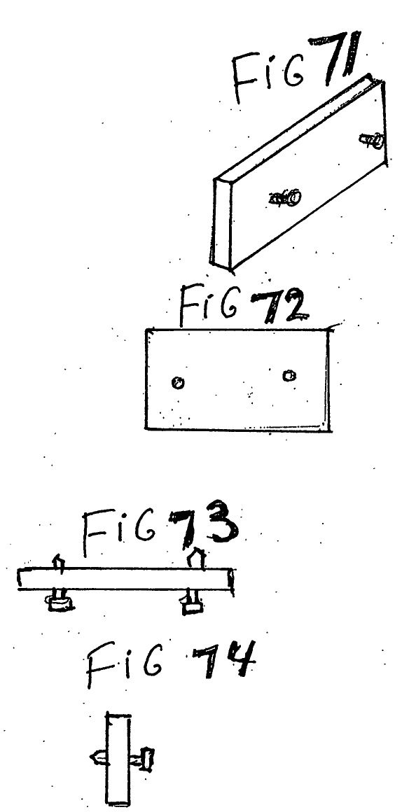

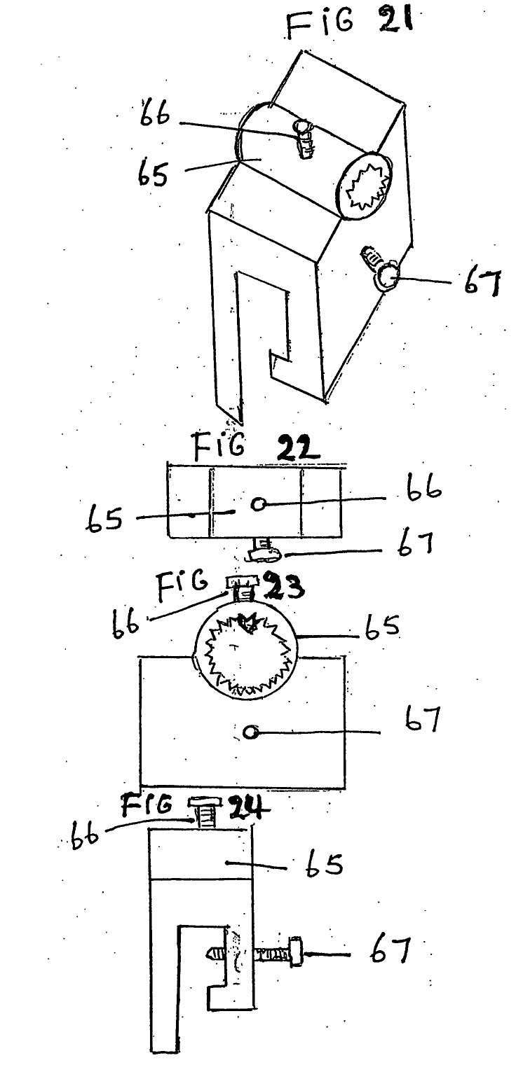

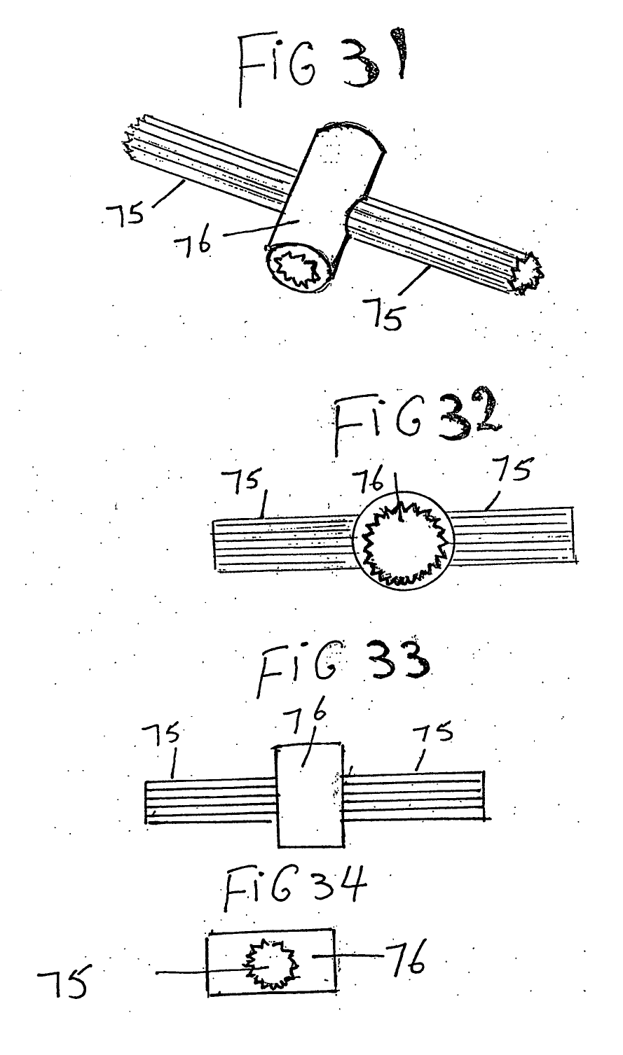

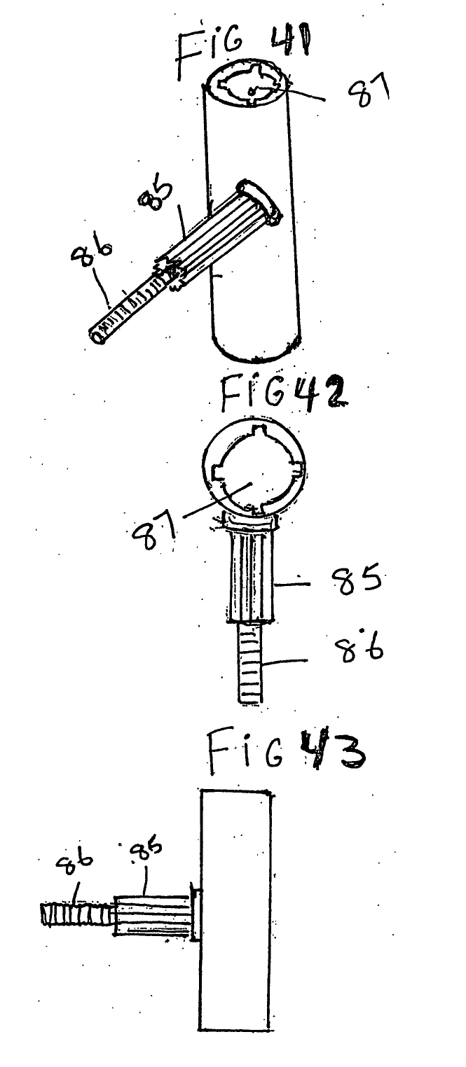

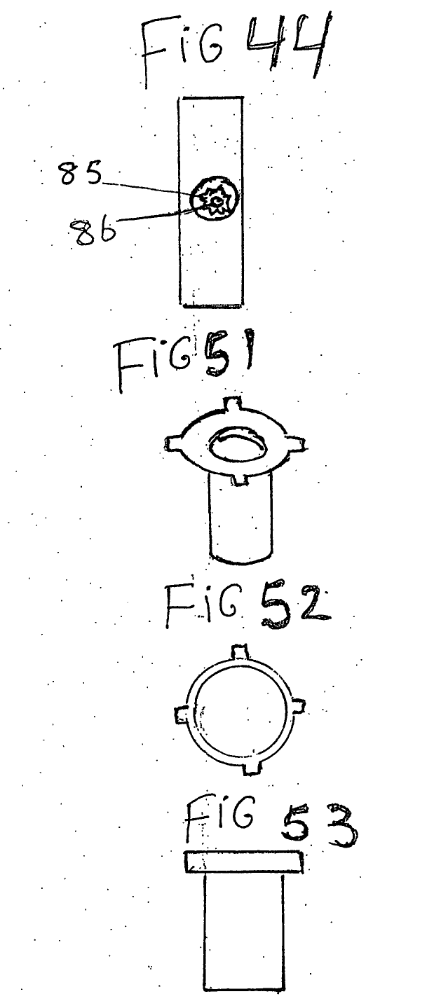

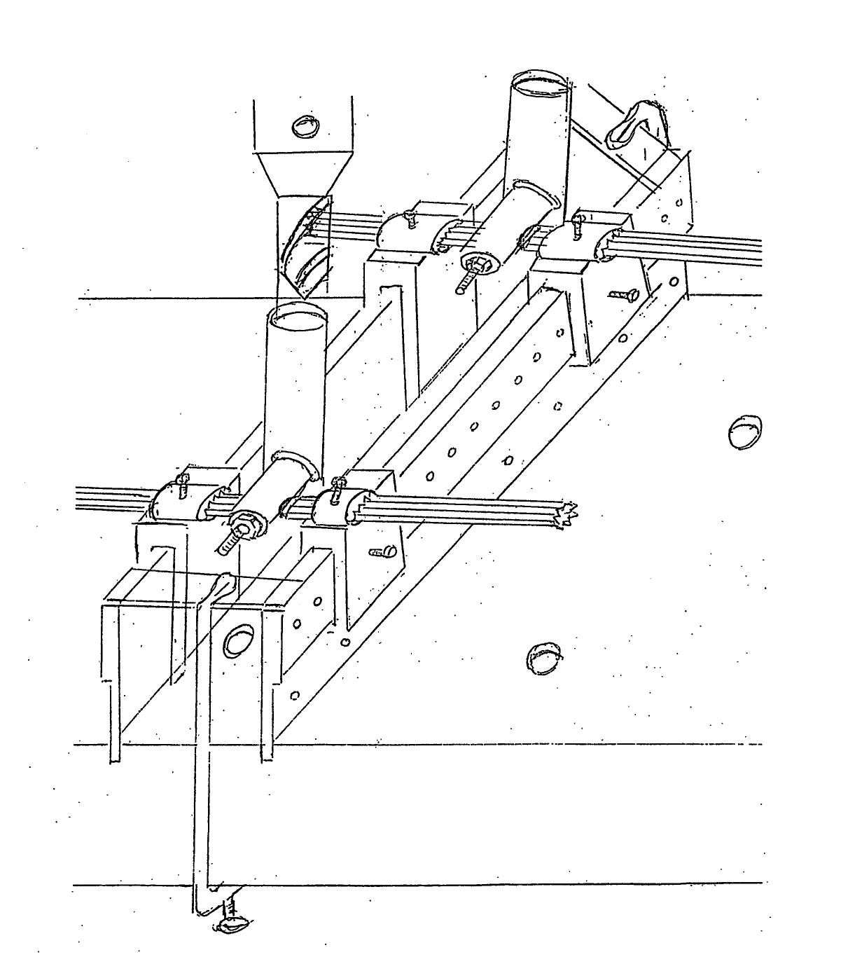

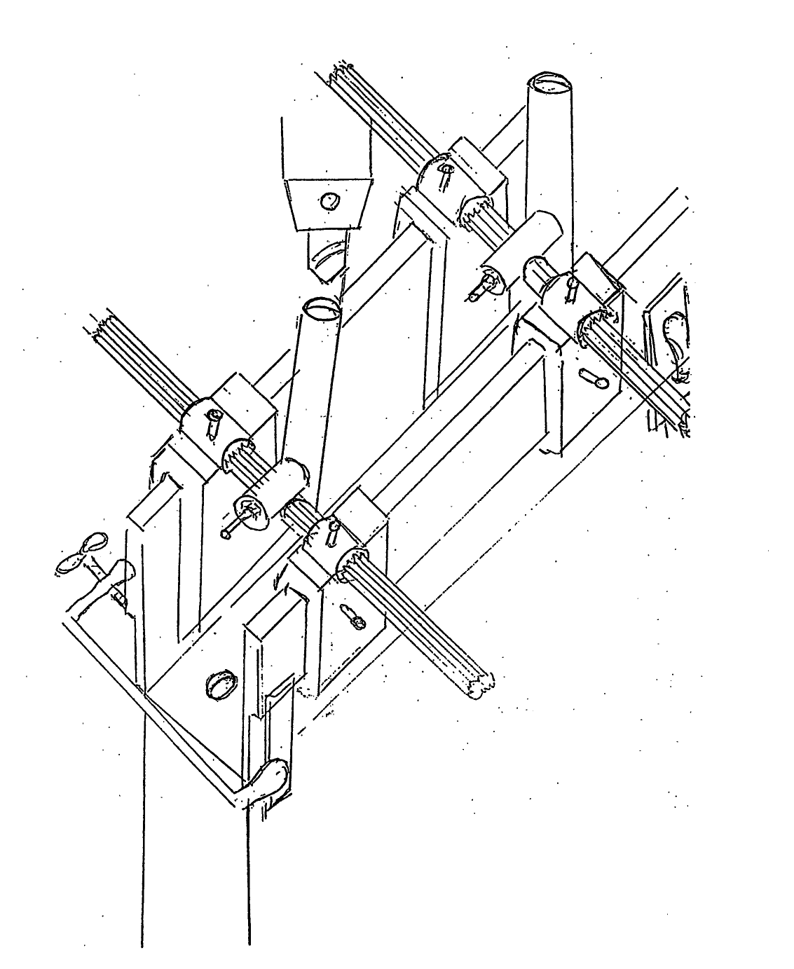

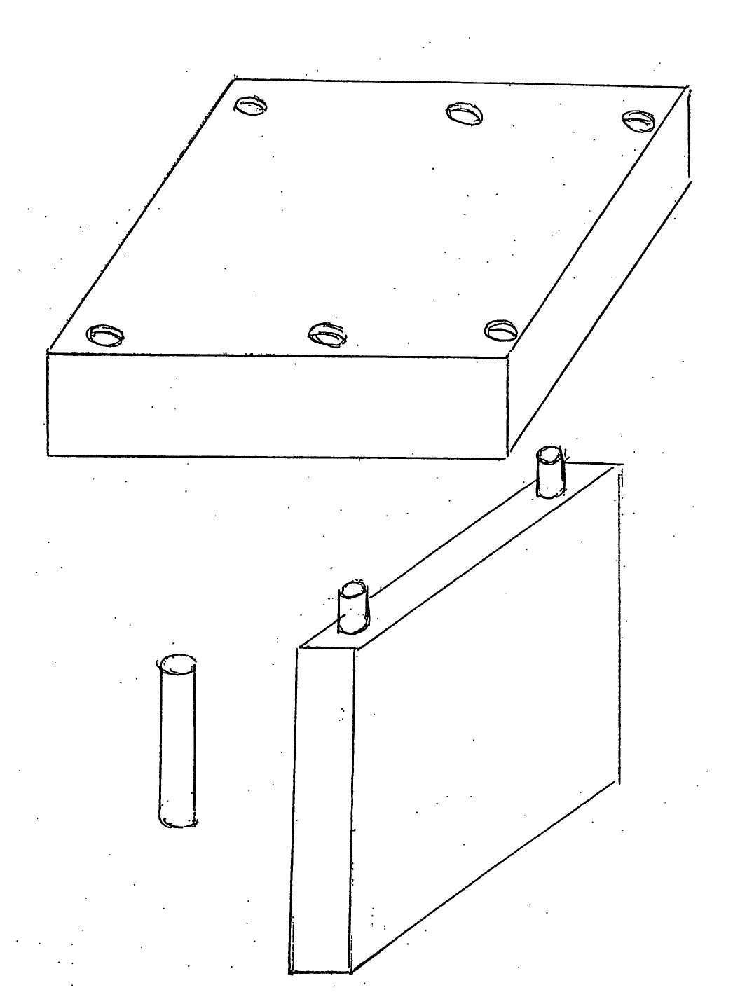

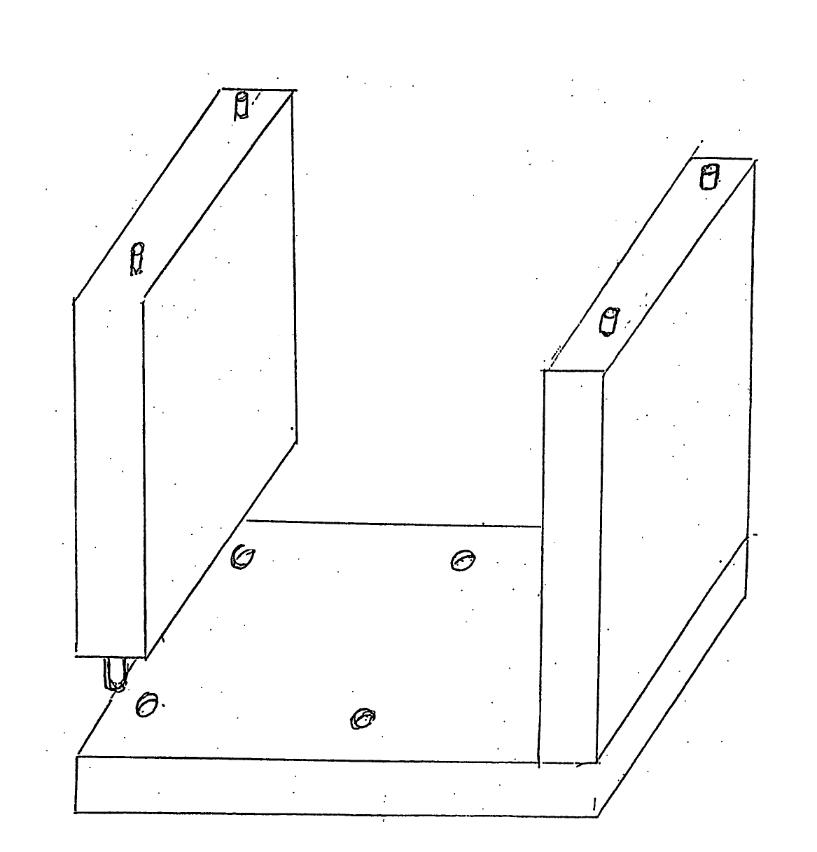

1. The invention is a fine arm for the electric drill, with [symbol] and easily operated.
This arm is used as one unit, and none of its parts can be used separately.
It is characterized by being able to be adjusted before use according to our needs.
It is characterized by having several cylinders installed on, see FIG. 87, FIG. 51 which enter into FIG. 87.
It is characterized by it ability to make holes at any poin in the thickness.
It is characterized at any point away from the beginning of the arm.
It is characterized by it ability to make holes with many angles in the direction of the axis of the arm.
It is characterized by it ability to make holes with many angles, in the direction perpendicular to the axis of the arm.
It is characterized by it ability to make holes with angles in both of the aforementioned directions.
It is characterized by it ability to make holes with different diameters.

2. The invention is a fine arm for the electric drill, with multiple uses, and easily operated.
This arm is used as one unit, and none of its parts can be used separately.
It is characterized by being able to be adjusted before use according to our needs.
It is characterized by having several cylinders installed on, see FIG. 87, FIG. 51 which enter into FIG. 87.
It is characterized by it ability to make holes at any poin in the thickness.
It is characterized at any point away from the beginning of the arm.
It is characterized by it ability to make holes with many angles in the direction of the axis of the arm.
It is characterized by it ability to make holes with many angles, in the direction perpendicular to the axis of the arm.
It is characterized by it ability to make holes with angles in both of the aforementioned directions.
It is characterized by it ability to make holes with different diameters.
Up on using this arm, it is characterized by: it should be adjusted before use.
It contains more than one, see FIG. 87 which enters into FIG. 51, thus allowing the electric drill to make holes more than once, after fixing the arm on each side, then it is used to make holes in the bases after fixing it on each base. That is to mean, the arm is adjusted according to A, B, C and D.
A. The dimension required from the beginning of the arm.
B. The thickness required.
C. The angle required, in the direction of the arm's axis, or in the direction perpendicular to the arm's axis or, in both of the aforementioned directions.
D. The diameter required, using a bite which is equal to it. After adjusting the arm
Firstly ( Sides) : We fix the arm on the side's thickness required, the we make holes by the electric drill, thus we obtain the number of holes required in the side without moving the arm on the side.
This method is used for all the sides, to obtain holes in them. We place the cylinder into the holes, thus the holes are made accurately and this doesn't take time and effort.
Unlike prior art, where the unit is moved on the side to obtain one hole every time, and this takes time, effort and increasing the probability of error.
Secondly (Bases) or ceiling
The arm is fixed on the base or the ceiling after adjusting it as required, then we make holes by the electric drill, to obtain the holes in the sites required exactly, unlike the prior art.
We place the side over the base, the cylinders of the sides enter thoroughly in the holes of the bases.
That is to mean, the arm is adjusted, them it is used for any number of sides and bases.

3. The invention is a fine arm for the electric drill, with multiple uses, and easily operated.
This arm is used as one unit, and none of its parts can be used separately.
It is characterized by being able to be adjusted before use according to our needs.
It is characterized by having several cylinders installed on, see FIG. 87, FIG. 51 which enter into FIG. 87.
It is characterized by it ability to make holes at any poin in the thickness.
It is characterized at any point away from the beginning of the arm.
It is characterized by it ability to make holes with many angles in the direction of the axis of the arm.
It is characterized by it ability to make holes with many angles, in the direction perpendicular to the axis of the arm.
It is characterized by it ability to make holes with angles in both of the aforementioned directions.
It is characterized by it ability to make holes with different diameters.
It is characterized by presence of more than one cylinder installed on, see FIG. 87 and FIG. 51 which enters into FIG. 87, thus allowing making more than hole every time, whether in the side or the base.
Up on fixing the arm on the side or the base, we make the holes required once, with out moving the arm therefore fulfilling precision and saving effort and time.

4. The invention is a fine arm for the electric drill, with multiple uses, and easily operated.
This arm is used as one unit, and none of its parts can be used separately.
It is characterized by being able to be adjusted before use according to our needs.
It is characterized by having several cylinders installed on, see FIG. 87, FIG. 51 which enter into FIG. 87.
It is characterized by it ability to make holes at any poin in the thickness.
It is characterized at any point away from the beginning of the arm.
It is characterized by it ability to make holes with many angles in the direction of the axis of the arm.
It is characterized by it ability to make holes with many angles, in the direction perpendicular to the axis of the arm.
It is characterized by it ability to make holes with angles in both of the aforementioned directions.
It is characterized by it ability to make holes with different diameters.
It is characterized by its ability to making a hole in the thickness at any point in the thickness as required; in the middle or whatever or whatever. It is always adjusted equal to the side's thickness.
This unit (arm) allows making holes in the side's bases, and ceiling in the carpentry up on making furniture, as it facilitates making holes through the presence of different thicknesses to be perforated through opining or closing it. By opining the two tacks 66 and 66 and adjusting according to the required thickness, then we fast the two tacks, thus it is fit for making holes in any thickness, as it is not confined to one thickness.
That is to mean,:
a. It is opened and closed according to the required thickness (perpendicularly to the arm's axis)
b. The center of the hole is determined in relation to the thickness as required. i . e, the center is moving (The hole's center is moving perpendicularly to the arm's axis). prior art, where the thickness and the center [symbol] n moving.

5. The invention is a fine arm for the electric drill, with multiple uses, and easily operated.
This arm is used as one unit, and none of its parts can be used separately.
It is characterized by being able to be adjusted before use according to our needs.
It is characterized by having several cylinders installed on, see FIG. 87, FIG. 51 which enter into FIG. 87.
It is characterized by it ability to make holes at any poin in the thickness.
It is characterized at any point away from the beginning of the arm.
It is characterized by it ability to make holes with many angles in the direction of the axis of the arm.
It is characterized by it ability to make holes with many angles, in the direction perpendicular to the axis of the arm.
It is characterized by it ability to make holes with angles in both of the aforementioned directions.
It is characterized by it ability to make holes with different diameters.
It is characterized by its ability to make holes at any point from the sta [symbol] point of the arm this unit (arm) allows up on using with the electric drill to change the distance from the sta [symbol] /point drill to change the distance from the sta [symbol] /point 56 by opening the two tacks 67 and 67, then fastening them according to the required distance. i.e, the distance from the start point is changes as required. Thus it is unlike prior art in which the distance is change by moving the unit each time.

6. The invention is a fine arm for the electric drill, with multiple uses, and easily operated.
This arm is used as one unit, and none of its parts can be used separately.
It is characterized by being able to be adjusted before use according to our needs.
It is characterized by having several cylinders installed on, see FIG. 87, FIG. 51 which enter into FIG. 87.
It is characterized by it ability to make holes at any poin in the thickness.
It is characterized at any point away from the beginning of the arm.
It is characterized by it ability to make holes with many angles in the direction of the axis of the arm.
It is characterized by it ability to make holes with many angles, in the direction perpendicular to the axis of the arm.
It is characterized by it ability to make holes with angles in both of the aforementioned directions.
It is characterized by it ability to make holes with different diameters.
It is characterized by its ability to allow obtaining a large number of angles in the direction of the axis of the two arms 11 and 11, by changing the position of 75 and 75 inside 65 and 65, then fastening the two tacks 66 and 66 according to the angle required.

7. The invention is a fine arm for the electric drill, with multiple uses, and easily operated.
This arm is used as one unit, and none of its parts can be used separately.
It is characterized by being able to be adjusted before use according to our needs.
It is characterized by having several cylinders installed on, see FIG. 87, FIG. 51 which enter into FIG. 87.
It is characterized by it ability to make holes at any poin in the thickness.
It is characterized at any point away from the beginning of the arm.
It is characterized by it ability to make holes with many angles in the direction of the axis of the arm.
It is characterized by it ability to make holes with many angles, in the direction perpendicular to the axis of the arm.
It is characterized by it ability to make holes with angles in both of the aforementioned directions.
It is characterized by it ability to make holes with different diameters.
It is characterized by its ability to allow obtaining a large number of angles in the direction of the axis, perpendicularly to 11 and 11, by changing the position of 85 inside 76, then fastening by the nut 61 according to the angle required.

8. The invention is a fine arm for the electric drill, with multiple uses, and easily operated.
This arm is used as one unit, and none of its parts can be used separately. It is characterized by being able to be adjusted before use according to our needs.
It is characterized by having several cylinders installed on, see FIG. 87, FIG. 51 which enter into FIG. 87.
It is characterized by it ability to make holes at any poin in the thickness.
It is characterized at any point away from the beginning of the arm.
It is characterized by it ability to make holes with many angles in the direction of the axis of the arm.
It is characterized by it ability to make holes with many angles, in the direction perpendicular to the axis of the arm.
It is characterized by it ability to make holes with angles in both of the aforementioned directions.
It is characterized by it ability to make holes with different diameters.
It is characterized by its ability to make holes in both of the aforementioned directions.
If we suppose that we obtain:
a-z angle in the direction of 11 and 11.
b-y angle perpendicular to 11 and 11, then we obtain a number of angles s=xy (angle).

9. The invention is a fine arm for the electric drill, with multiple uses, and easily operated.
This arm is used as one unit, and none of its parts can be used separately.
It is characterized by being able to be adjusted before use according to our needs.
It is characterized by having several cylinders installed on, see FIG. 87, FIG. 51 which enter into FIG. 87.
It is characterized by it ability to make holes at any poin in the thickness.
It is characterized at any point away from the beginning of the arm.
It is characterized by it ability to make holes with many angles in the direction of the axis of the arm.
It is characterized by it ability to make holes with many angles, in the direction perpendicular to the axis of the arm.
It is characterized by it ability to make holes with angles in both of the aforementioned directions.
It is characterized by it ability to make holes with different diameters.
This unit (arm) allows using a large number of the bites of the electric drill, which enter into 87 by changing the units 51 (51 a large number of 51).
51 has different inner diameters and constant external diameter which enter into 87 tightly. Thus we use different electric drill's bites:
4 mm , 5 mm , and 6 mm . . . Etc.
